(19) United States
(12) Patent Application Publication
(10) Pub. No.: US 2025/0133168 A1
(43) Pub. Date: Apr. 24, 2025

(54) IMAGE FORMING APPARATUS, CONTROL METHOD, AND NON-TRANSITORY COMPUTER-READABLE RECORDING MEDIUM

(71) Applicant: Konica Minolta, Inc., Tokyo (JP)

(72) Inventor: Kazuhiro Ishiguro, Toyohashi-shi (JP)

(73) Assignee: Konica Minolta, Inc., Tokyo (JP)

(21) Appl. No.: 18/922,705

(22) Filed: Oct. 22, 2024

(30) Foreign Application Priority Data
Oct. 24, 2023 (JP) 2023-182674

(51) Int. Cl. H04N 1/00

(52) U.S. Cl. CPC H04N 1/00029; H04N 1/00005; H04N 1/00039; H04N 1/00079; H04N 1/00087; H04N 1/00824

(57) ABSTRACT

An image forming apparatus that executes a job and outputs an image includes a hardware processor that: receives input of failure information indicating that a failure has occurred due to execution of the job; acquires state information inside the image forming apparatus when receiving the input of the failure information;
outputs the state information for failure analysis; determines whether or not a predetermined event has occurred during a period from the execution of a most recent job to the input of the failure information when the input of the failure information is received; and restricts output of the state information at the time of the output for failure analysis when the predetermined event has occurred.

### CROSS REFERENCE TO RELATED APPLICATIONS

The present application is based on Japanese Patent Application No. 2023-182674 filed on Oct. 24, 2023, the contents of which are incorporated herein by reference.

### BACKGROUND OF THE INVENTION

### Technical Field

The present invention relates to an image forming apparatus, a control method, and a non-transitory computer-readable recording medium.

### Description of the Related Art

An image forming apparatus such as an MFP (Multifunction Peripheral) executes various jobs such as a scan job, a print job, and a copy job. When such a job is executed in the image processing apparatus, a faulty image may be output.

Conventionally, there has been known an image forming apparatus of this type that, when a faulty image is outputted, reprints, on a sheet, image data and output-setting information specified by a user and outputs the sheet (e.g., Patent Literature: JP2008-97227A). In this conventional technology, the reprinted sheet is transmitted to the manufacturer by the FAX function of the image forming apparatus, and is used for identifying the cause of a failure or the like.

Incidentally, even when a faulty image is output, the image forming apparatus does not recognize the occurrence of a failure in many cases. For example, in a case where dirt is adhered to platen glass of the scanner section, the dirt generates noise in an output image. However, when dirt on the platen glass is not detected, the image forming apparatus does not detect occurrence of the failure even if noise occurs in an output image.

That is, in a case where there is a failure with an image output by the image forming apparatus, it is often the user who recognizes the problem. When the user recognizes the failure of the image, the user instructs the occurrence of the failure to the operation panel of the image forming apparatus. The image forming apparatus transmits information input by a user and state information inside the apparatus to the service center, and requests the service center to specify the cause of the occurrence of the faulty image. At the service center, an operator analyzes a failure with reference to the information input by the user and the state information on the image forming apparatus to identify the cause of the faulty image. The state information of the image forming apparatus is useful for specifying the state of the apparatus at the time of occurrence of the faulty image. Then, when the cause of the failure can be specified, the operator guides the user to a countermeasure for the failure, such as component replacement or cleaning of the platen glass. Furthermore, the operator may send a service person to the installation location of the image forming apparatus to perform the work.

However, in a case where an image output by the image forming apparatus includes a failure, a user may change a setting state of the image forming apparatus in an attempt to resolve the failure by himself/herself. Then, in a case where the malfunction cannot be solved even after the setting state is changed several times, the user may transmit state information of the image forming apparatus to a service center. In this case, the state information of the image forming apparatus has already been changed from the information at the time of the occurrence of the failure. The information that has been changed from the information at the time of occurrence of the failure hinders accurate identification of the cause of the failure. Therefore, even if the operator analyzes the state information acquired from the image forming apparatus, it is difficult for the operator to efficiently and accurately specify the cause of the failure.

In addition, after an image is output by the image forming apparatus, a user may notice that there is the failure in the output image after a certain period of time elapses. In this case, the status information on the image forming apparatus may have already been changed by another user when the user becomes aware of the failure. In addition, when image stabilization processing or the like is automatically executed in the image forming apparatus, state information inside the apparatus may be changed by the automatically executed processing. Furthermore, the internal temperature, humidity, and the like of the image forming apparatus may have already changed from the time of occurrence of the failure. Therefore, even if the user transmits the state information of the inside of the apparatus to the service center at the timing when the user notices the failure of the image, it may be difficult for the operator to efficiently and accurately specify the cause of the occurrence of the failure.

Therefore, among the information included in the state information of the image forming apparatus, information that has been changed from the information at the time of occurrence of the failure should be excluded from the information to be referred to when the cause of the failure is identified.

### SUMMARY OF THE INVENTION

The present invention provides an image forming apparatus, a control method, and a non-transitory computer-readable recording medium that solve the above-described conventional problems. That is, an object of the present invention is to restrict output of state information under a predetermined condition when an image failure occurs.

In order to achieve the above object, first, the present invention is directed to an image forming apparatus for executing a job and outputting an image.

In one aspect of the present invention, the image forming apparatus includes a hardware processor that: receives input of failure information indicating that a failure has occurred due to execution of the job; acquires state information inside the apparatus when receiving the input of the failure information; outputs the state information for failure analysis; determines whether or not a predetermined event has occurred during a period from the execution of the most recent job to the input of the failure information when the input of the failure information is received; and restricts output of the state information at the time of the output for failure analysis when the predetermined event has occurred.

Second, the present invention is directed to a control method in a case where a failure occurs in an image outputted in an image forming apparatus that executes a job and outputs an image.

In one aspect of the present invention, the control method includes: receiving input of failure information indicating that the failure has occurred due to execution of the job; acquiring state information inside the image forming apparatus in response to receiving input of the failure information; outputting the state information for failure analysis; determining whether or not a predetermined event has occurred during a period from execution of the most recent job to the input of the failure information when input of the failure information is received; and restricting the output of the state information at the time of output for failure analysis when the predetermined event has occurred.

Third, the present invention is directed to a non-transitory computer-readable recording medium storing a program to be executed in an image forming apparatus that executes a job and output an image.

In one aspect of the present invention, the program causes the image forming apparatus to perform: receiving input of failure information indicating that the failure has occurred due to execution of the job; acquiring state information inside the image forming apparatus in response to receiving input of the failure information; outputting the state information for failure analysis; determining whether or not a predetermined event has occurred during a period from execution of the most recent job to the input of the failure information when input of the failure information is received; and restricting the output of the state information at the time of output for failure analysis when the predetermined event has occurred.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an example of the configuration of an image forming apparatus;

FIG. 2 is a block diagram illustrating an example of a hardware configuration of the image forming apparatus;

FIG. 3 is a block diagram illustrating an example of a functional configuration of a controller;

FIG. 4 illustrates an example of history information recorded by an event recording section;

FIG. 5 is a flowchart illustrating an example of a processing procedure performed in the image forming apparatus;

FIG. 6 illustrates an example of an operation screen;

FIG. 7 illustrates an example of an operation screen;

FIG. 8 illustrates an example of an operation screen;

FIG. 9 illustrates an example of an operation screen;

FIG. 10 illustrates an example of an operation screen;

FIG. 11 illustrates an example of an operation screen;

FIG. 12 illustrates a relationship between failure detailed information and a cause of a failure;

FIGS. 13A, 13B and 13C illustrate examples of failure analysis datasets output from the image forming apparatus;

FIG. 14 is a flowchart illustrating an example of a processing procedure performed in the image forming apparatus of the second embodiment;

FIG. 15 is a flowchart illustrating an example of a processing procedure performed in the image forming apparatus of the second embodiment;

FIG. 16 is a block diagram illustrating a functional configuration of a controller in the image forming apparatus of the third embodiment;

FIGS. 17A and 17B illustrate an example of the operation screen.

FIGS. 18A, 18B and 18C illustrate screen examples for guiding a user to a solution to a failure.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference signs, and redundant description thereof is omitted.

### First Embodiment

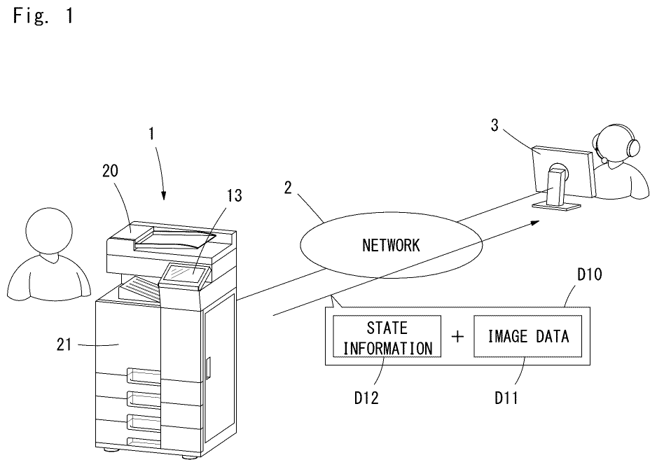

FIG. 1 illustrates a configuration example of an image forming apparatus 1 according to a first embodiment of the present invention. For example, the image forming apparatus 1 is an apparatus called an MFP or the like. The image forming apparatus 1 is installed in an office or the like and is used by a user. The image forming apparatus 1 includes a scanner section 20 and a printer section 21, and can execute various jobs such as a print job, a scan job, and a copy job. The image forming apparatus 1 further includes an operation panel 13. The image forming apparatus 1 executes a job specified by a user via the operation panel 13. The image forming apparatus 1 also has a FAX function and can execute a FAX transmission job and a FAX reception job.

The image forming apparatus 1 is connected to a network 2 including a local area network (LAN) and the Internet. The image forming apparatus 1 can execute a job received via the network 2. For example, when receiving a print job via the network 2, the image forming apparatus 1 executes the print job to produce a printed output.

An information processing apparatus 3 of a service center is connected to the network 2. The image forming apparatus 1 can communicate with the information processing apparatus 3 via the network 2. The information processing apparatus 3 is used by an operator stationed at the service center. For example, when a failure occurs in the image forming apparatus 1, the information processing apparatus 3 acquires the failure analysis data D10 output from the image forming apparatus 1. The operator analyzes the failure analysis data D10 to determine the cause of the failure occurring in the image forming apparatus 1 and provide guidance to the user of the image forming apparatus 1 on how to resolve the failure.

The image forming apparatus 1 may cause a failure in an image to be output by execution of a job. Examples of the failure included in the output image include streaky noise and dot-like noise. Even when a failure occurs in an output image, the image forming apparatus 1 often does not recognize the failure as a trouble. Therefore, at the time point when failure information indicating that the failure has occurred is input to the operation panel 13 by a user, the image forming apparatus 1 detects that the failure has occurred in an output image.

When the failure information is input by the user, the image forming apparatus 1 generates the failure analysis data D10 and outputs the failure analysis data D10. The image forming apparatus 1 of the present embodiment transmits the failure analysis data D10 to the information processing apparatus 3 of the service center. The operator causes the information processing apparatus 3 to display information included in the failure analysis data D10 for failure analysis, and specifies the cause of the failure occurring in the image forming apparatus 1. For example, the failure analysis data D10 includes the image data D11 including the failure and the state information D12 of the image forming apparatus 1.

When the failure information is input by the user, the image forming apparatus 1 acquires the image data D11 including the failure, based on the user's instruction. For example, when the failure is included in a print image output by executing a print job, the image forming apparatus 1 drives the scanner section 20 to read an image printed on a sheet, and generates the image data D11. When the scanned image output by executing the scan job includes the failure, the image forming apparatus 1 acquires the scanned image from the storage area in which the scanned image has been output and stored, and generates the image data D11.

Furthermore, the image forming apparatus 1 acquires the state information D12 on the inside of the image forming apparatus 1 at the timing when the failure information is input by the user. The state information D12 includes various kinds of setting information held inside the image forming apparatus 1, environment information inside the apparatus, and the like.

The setting information includes, in addition to setting values applied at the time of execution of various jobs, image processing parameters applied at the time of image processing, control parameters applied at the time of image reading or image formation, and the like. Setting values to be applied in execution of various jobs are information whose settings can be changed by a user. In contrast, the image processing parameters and the control parameters are information that cannot be changed by the user. However, the image processing parameters and the control parameters are information that is changed as appropriate by automatic processing such as image stabilization processing that is automatically executed regularly or irregularly in the image forming apparatus 1. The image forming apparatus 1 acquires the above-described setting information at the timing when the failure information is input by the user.

The environment information includes information such as temperature and humidity inside the image forming apparatus 1. The image forming apparatus 1 includes a temperature sensor and a humidity sensor therein. The image forming apparatus 1 acquires the environment information from these sensors at the timing when the failure information is input by the user. Note that the environment information may include information other than temperature and humidity.

Then, the image forming apparatus 1 generates the failure analysis data D10 including the image data D11 and the state information D12, and transmits the failure analysis data D10 to the information processing apparatus 3. However, in a case where the user does not notice that a failure is included in the outputted image immediately after the image forming apparatus 1 executes the job, the state information D12 of the image forming apparatus 1 may be changed from the information immediately after the job execution. In that case, even if the state information D12 provided from the image forming apparatus 1 is analyzed, it is difficult for the operator to accurately and efficiently specify the cause of the failure. Rather, the state information D12 provided from the image forming apparatus 1 is information that confuses the determination of the operator when the operator specifies the cause of the occurrence of the failure.

Therefore, the image forming apparatus 1 of the present embodiment determines whether or not the state information D12 is the information at the time of occurrence of the failure when outputting the failure analysis data D10. As a result of the determination, when the state information D12 is different from the information at the time of the occurrence of the failure, the image forming apparatus 1 restricts output of the state information D12. Hereinafter, such an image forming apparatus 1 will be described in detail.

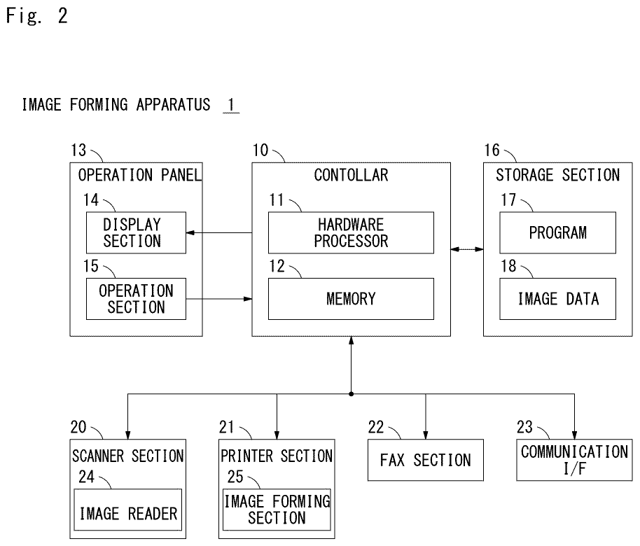

FIG. 2 is a block diagram illustrating an example of a hardware configuration of the image forming apparatus 1. The image forming apparatus 1 includes a controller 10, an operation panel 13, a storage section (or storage) 16, a scanner section 20, a printer section 21, a FAX section 22, and a communication interface 23.

The controller 10 integrally controls the operation of the image forming apparatus 1. The controller 10 includes a hardware processor 11 and a memory 12. The hardware processor 11 reads and executes a program 17 stored in the storage section 16. The memory 12 stores temporary data and the like generated as the hardware processor 11 executes the program 17. For example, the memory 12 is a volatile storage device.

The operation panel 13 is a user interface used when a user uses the image forming apparatus 1. The operation panel 13 includes a display section 14 that displays various operation screens that can be operated by a user and an operation section (or operation device) 15 that receives an operation of the user. The display section 14 is composed of, for example, a color liquid crystal display. The operation section 15 includes, for example, touch screen keys arranged on the screen of the display section 14.

The storage section 16 is a nonvolatile storage device constituted by a hard disk drive (HDD), a solid state drive (SSD), or the like. The storage section 16 stores in advance a program 17 to be executed by the hardware processor 11. In addition, the storage section 16 stores image data 18 acquired along with the execution of the job. For example, in the case of a print job, the storage section 16 stores image data 18 acquired as an object to be printed. In the case of a scan job or a copy job, the image data 18 generated by the scanner section 20 is stored in the storage section 16.

The storage section 16 only needs to store at least one piece of image data 18 acquired in the most recent job. However, it is not limited to this. The storage section 16 may accumulate and store the image data 18 acquired in each of multiple jobs executed by the image forming apparatus 1. The storage section 16 also stores various kinds of information other than the program 17 and the image data 18.

The scanner section 20 operates when a scan job or a copy job is executed. The scanner section 20 includes an image reader 24. The image reader 24 optically reads an image of a document set by a user to generate image data. For example, the image reader 24 optically reads a document placed on a platen glass. The scanner section 20 may include an automatic document feeder (ADF). The image reader 24 reads an image and generates image data when a document automatically conveyed continuously by the automatic document feeder passes through the position of the slit glass.

The printer section 21 operates when a print job or a copy job is executed. The printer section 21 includes an image forming section 25. The image forming section 25 forms an image on a sheet such as a printing sheet on the basis of image data to be printed, and prints out the image. For example, the image forming section 25 forms an image on the sheet by an electrophotographic method. However, the present invention is not limited thereto, and the image forming section 25 may form an image on a sheet by an ink jet method.

FAX section 22 transmits and receives FAX data through a public telephone network. Upon receiving the FAX data, the FAX section 22 outputs image data included in the FAX data to the printer section 21. When the FAX section 22 acquires from the scanner section 20 image data to be transmitted, the FAX section 22 converts the image data into FAX data and transmits the FAX data to a designated transmission destination.

The communication interface 23 connects the image forming apparatus 1 to the network 2. The communication interface 23 communicates with an external apparatus, such as the information processing apparatus 3, via the network 2.

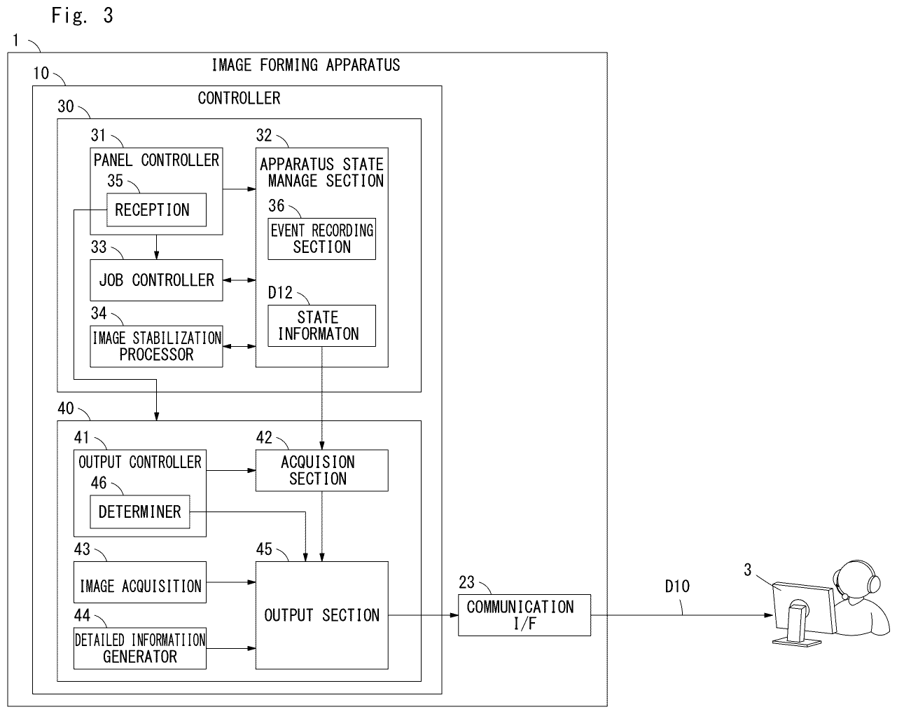

FIG. 3 is a block diagram illustrating an example of a functional configuration of the controller 10. When the hardware processor 11 executes the program 17, the controller 10 functions as a normal operation controller 30 and a failure controller 40. The normal operation controller 30 functions when the image forming apparatus 1 is in the normal operation mode. The normal operation mode is an operation mode in which the image forming apparatus 1 can execute a job. The failure controller 40 operates when the image forming apparatus 1 shifts from the normal operation mode to the failure mode. For example, when input of failure information by a user is accepted in the normal operation mode, the operation mode of the image forming apparatus 1 shifts from the normal operation mode to the failure mode.

The normal operation controller 30 includes a panel controller 31, an apparatus state managing section 32, a job controller 33, and an image stabilization processor 34.

The panel controller 31 controls the operation panel 13 in the normal operation mode. That is, the panel controller 31 displays an operation screen which can be operated by the user on the display section 14, and receives an operation of the user on the operation screen. For example, in the normal operation mode, upon receipt of a user's job setting operation, the panel controller 31 outputs a setting value based on the setting operation to the apparatus state managing section 32. Further, when receiving an instruction to execute a job from the user, the panel controller 31 instructs the job controller 33 to start execution of the job.

The panel controller 31 includes a reception 35. The reception 35 accepts input of failure information indicating that the failure has occurred in the normal operation mode. For example, on the operation screen displayed on the display section 14 in the normal operation mode, an operation button to be operated by the user when the failure occurs is displayed. When the operation button is operated by the user, the reception 35 receives the operation of the user as failure information. When receiving the failure information, the reception 35 shifts the operation mode from the normal operation mode to the failure mode, and causes the failure controller 40 to function.

The apparatus state managing section 32 manages the state of the image forming apparatus 1. The apparatus state managing section 32 records and manages the state of the image forming apparatus 1 in the state information D12. The apparatus state managing section 32 updates the state information D12 each time the state of the image forming apparatus 1 changes. Therefore, the state information D12 is information representing the internal state of the image forming apparatus 1 in real time. The state information D12 includes various kinds of setting information, environment information inside the apparatus, and the like as described above.

For example, upon receiving the setting values of the job from the panel controller 31, the apparatus state managing section 32 updates the setting information included in the state information D12. When the execution instruction of the job by the user is received, the apparatus state managing section 32 outputs information necessary for executing the job from the state information D12 to the job controller 33. As a result, the job controller 33 can execute the job in a state in which the setting value of the job designated by the user is reflected.

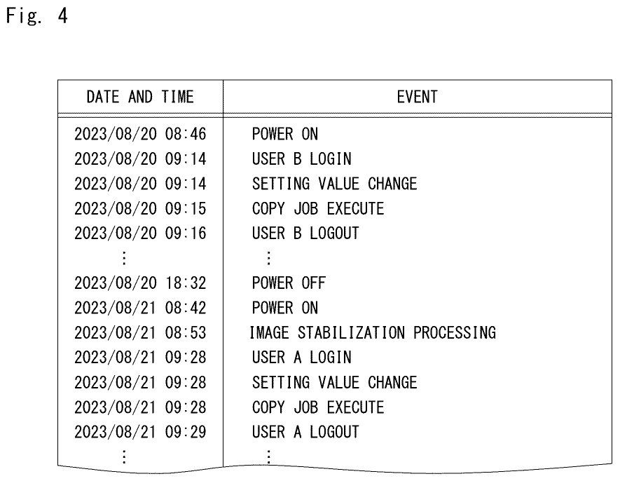

The apparatus state managing section 32 includes an event recording section 36. The event recording section 36 detects an event that occurs in the image forming apparatus 1, and records an event occurrence history in the history information. FIG. 4 illustrates an example of history information recorded by the event recording section 36. As illustrated in FIG. 4, in the history information, histories such as power-on, user login, change of a setting value, execution of a job, processing automatically executed in the image forming apparatus 1 such as image stabilization processing, user logout, and power-off are recorded. Furthermore, the event recording section 36 also detects a change in the internal environment (temperature and humidity) of the image forming apparatus 1 as an event, and records the change in the internal environment in the history information. Note that the history information is managed in a state of being saved in the storage section 16, for example.

The job controller 33 controls execution of a job in the image forming apparatus 1. For example, in the case of a scan job, the job controller 33 drives the scanner section 20 based on a job execution instruction by the user, and controls an image reading operation of a document set by the user. In the case of a print job, the job controller 33 drives the printer section 21 to form and output an image on a sheet based on the image data to be printed. In the case of a copy job, the job controller 33 drives the scanner section 20 and the printer section 21 to print out an image obtained by copying an image read by the scanner section 20.

The job controller 33 outputs the image data 18 acquired along with the execution of the job to the storage section 16 and stores the image data 18 in the storage section 16. For example, in the case of a print job, the job controller 33 stores the image data 18 to be printed in the storage section 16. In the case of a scan job or a copy job, the job controller 33 stores the image data 18 generated by the scanner section 20 in the storage section 16.

The image stabilization processor 34 operates regularly or irregularly in the normal operation controller 30. The image stabilization processor 34 performs processing for stabilizing an image to be output by the image forming apparatus 1. For example, the image stabilization processor 34 drives the printer section 21 and automatically executes processing for maintaining the reproducibility of the color of the printed image in a constant state. When the image stabilization processor is executed by the image stabilization processor 34, the control parameter applied at the time of image formation is changed. Along with this, the state information D12 is updated.

The image forming apparatus 1 may automatically execute processing other than the image stabilization processing. Also in that case, the state information D12 may be updated.

The failure controller 40 includes an output controller 41, an acquisition section 42, an image acquisition 43, a detailed information generator 44, and an output section 45.

The output controller 41 controls outputting of the failure analysis data D10 in the failure mode. Upon transition to the failure mode, the output controller 41 causes the acquisition section 42 to function. Furthermore, when the mode is switched to the failure mode, the output controller 41 prohibits automatic execution of image stabilization processing and the like. Therefore, the state information D12 is not automatically rewritten by the image stabilization processing or the like in the failure mode.

The acquisition section 42 acquires the state information D12 managed by the apparatus state managing section 32. That is, the acquisition section 42 acquires the state information D12 at the timing when the mode has shifted to the failure mode. Upon acquiring the state information D12, the acquisition section 42 outputs the state information D12 to the output section 45.

The output controller 41 includes a determiner 46. The determiner 46 determines whether or not a predetermined event has occurred during a period from execution of the most recent job to input of the failure information. The determiner 46 refers to the history information managed by the event recording section 36. Based on the history information, the determiner 46 determines whether or not a predetermined event has occurred after the execution of the most recent job in the image forming apparatus 1.

The predetermined event is an event in which the state information D12 may be changed. Such events include an event that changes an internal setting state of the image forming apparatus 1. For example, the predetermined event includes an event indicating a transition to a logged in state by a user different from a user who has executed the most recent job, an event of executing image stabilization processing, and the like. Furthermore, when a predetermined time has elapsed since the execution of the most recent job, the setting value of the job changed by the user returns to the default value. Therefore, the lapse of a predetermined time from the execution of the most recent job is also included in the predetermined event. The power-off and power-on of the image forming apparatus 1 are also included in the predetermined event. Furthermore, a change in temperature, humidity, or the like inside the image forming apparatus 1 is also included in the predetermined event.

When a predetermined event has not occurred after the execution of the most recent job, the output controller 41 does not restrict the outputting of the state information D12 by the output section 45. In contrast, if the predetermined event has occurred after execution of the most recent job, the output controller 41 restricts outputting of the state information D12 by the output section 45.

One aspect of the outputting restriction is to prohibit outputting of the state information D12. In this case, the output controller 41 prohibits the output section 45 from outputting the failure analysis data D10 including the state information D12. In addition, the output controller 41 may perform control such that the analysis processing for specifying the cause of the failure is not performed.

Another aspect of the outputting restriction is to invalidate at least one part of information among multiple information included in the state information D12, and to cause the output section 45 to perform outputting. For example, the output controller 41 specifies information that has been changed by the event that has occurred after the execution of the most recent job, from among the information included in the state information D12. Next, the output controller 41 instructs the output section 45 to invalidate the information changed due to the occurrence of the event.

For example, in the output controller 41, it is set in advance which of the above two aspects is used to perform the output restriction. In this case, when a predetermined event occurs during a period from the execution of the most recent job to the input of the failure information, the output controller 41 restricts the outputting of the state information D12 in a preset aspect. However, it is not limited to this.

The image acquisition 43 acquires the image data D11 of the image including the failure. For example, in response to a user's instruction to acquire a faulty image, the image acquisition 43 drives the scanner section 20. The image acquisition 43 acquires the image data of the image read by the image reader 24 of the scanner section 20 as the image data D11 including the failure. Furthermore, in a case where the image including the failure is output by a scan job, the image acquisition 43 reads, from the storage section 16, the image data 18 generated by the most recent scan job, and acquires it as the image data D11 including the failure. Upon acquiring the image data D11 including the failure, the image acquisition 43 outputs the image data D11 to the output section 45.

The detailed information generator 44 functions when input of detailed information at the time of occurrence of the failure is instructed by the user. The detailed information generator 44 displays an operation screen on which the user can input detailed information on the display section 14 of the operation panel 13. When the input operation of the failure detailed information by the user is received by the operation section 15 of the operation panel 13, the detailed information generator 44 generates the failure detailed information based on the input operation. Upon generating the failure detailed information, the detailed information generator 44 outputs the failure detailed information to the output section 45.

The output section 45 outputs the failure analysis data D10. The outputting of the failure analysis data D10 by the output section 45 is controlled by the output controller 41. For example, when the outputting of the failure analysis data D10 including the state information D12 is prohibited by the output controller 41, the output section 45 generates the failure analysis data D10 not including the state information D12. That is, the output section 45 generates the failure analysis data D10 including only the image data D11 outputted from the image acquisition 43. At this time, if the output section 45 has acquired the failure detailed information from the detailed information generator 44, the output section 45 generates the failure analysis data D10 including the image data D11 and the failure detailed information. Then, the output section 45 transmits the failure analysis data D10 to the information processing apparatus 3 via the communication interface 23.

Furthermore, when the output controller 41 instructs to invalidate at least one part of the information among multiple information included in the state information D12, the output section 45 deletes the information instructed to be invalidated from the state information D12 outputted from the acquisition section 42. Then, the output section 45 generates the failure analysis data D10 including the image data D11 and the state information D12 in which at least one part of the information is invalidated. At this time, if the output section 45 has acquired the failure detailed information from the detailed information generator 44, the output section 45 generates the failure analysis data D10 further including the failure detailed information. Then, the output section 45 transmits the failure analysis data D10 to the information processing apparatus 3 via the communication interface 23.

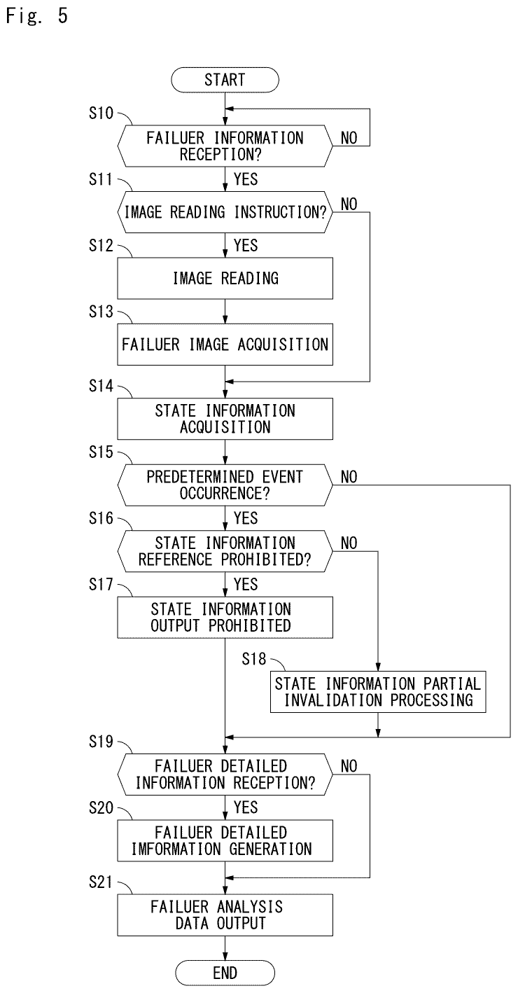

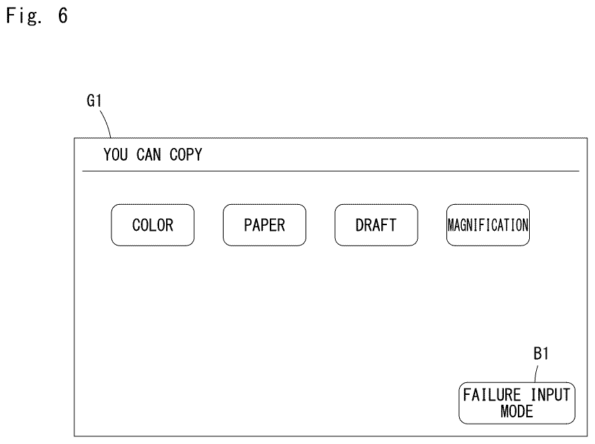

FIG. 5 is a flowchart illustrating an example of a processing procedure performed in the image forming apparatus 1. This processing is processing mainly performed by the failure controller 40. The image forming apparatus 1 waits until input of failure information by the user is accepted (step S10). For example, in the normal operation mode, an operation screen G1 as illustrated in FIG. 6 is displayed on the display section 14 of the operation panel 13. The operation screen G1 includes operation buttons B1 for the user to input the failure information. When the operation button B1 is operated by the user, the image forming apparatus 1 receives the operation as an input of the failure information.

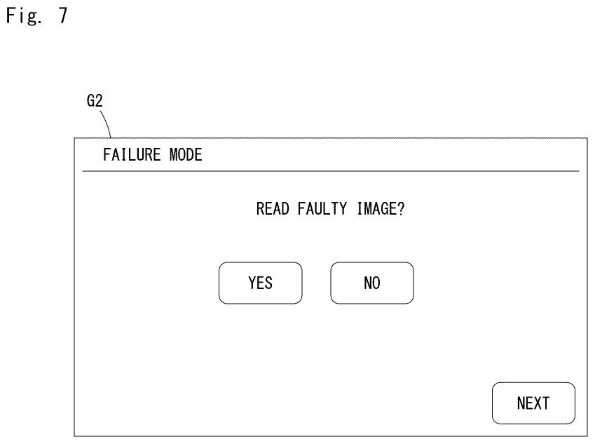

When input of the failure information is accepted (YES in step S10), the image forming apparatus 1 transitions to the failure mode. When the image forming apparatus 1 enters the failure mode, the image forming apparatus 1 displays an operation screen G2 as illustrated in FIG. 7 on the display section 14 of the operation panel 13. The operation screen G2 is a screen for inquiring of a user whether or not to perform reading of an image in which a failure has occurred. The user can provide an image reading instruction by performing an operation on the operation screen G2.

Upon transitioning to the failure mode, the image forming apparatus 1 determines whether or not there has been an image reading instruction by the user (step S11). When the image reading instruction has been issued (YES in step S11), the image forming apparatus 1 drives the scanner section 20 to read the image of the document (step S12), and acquires the image data D11 of the image including the failure (step S13). Furthermore, the image forming apparatus 1 may not only read the image of the document but also acquire the image data D11 of the image including the failure from the image data 18 stored in the storage section 16. In a case where there is no image reading instruction from the user (NO in step S11), the image forming apparatus 1 may not acquire an image including the failure.

Next, the image forming apparatus 1 acquires the state information D12 indicating the state of the image forming apparatus 1 at the current time point (step S14). Here, the acquisition section 42 acquires the state information D12 managed by the apparatus state managing section 32.

Next, the image forming apparatus 1 determines whether or not a predetermined event has occurred during a period from the execution of the most recent job to the current time point (step S15). That is, the image forming apparatus 1 determines whether or not an event that may change the state information D12 has occurred after the execution of the most recent job. As a result, when the predetermined event has not occurred (NO in step S15), the state information D12 read in step S14 is the same as the information immediately after the execution of the most recent job. Therefore, when the predetermined event does not occur (NO in step S15), the processing of steps S16 to S18 are skipped.

On the other hand, when the predetermined event has occurred (YES in step S15), there is a possibility that the state information D14 read in step S14 has been changed after the execution of the most recent job. Therefore, the image forming apparatus 1 restricts output of the state information D12 acquired in step S14 (steps S16 to S18).

If the predetermined event has occurred (YES in step S15), the image forming apparatus 1 determines whether or not to prohibit reference to the state information D12 (step S16). For example, when the reference to the state information D12 is prohibited in advance (YES in step S16), the image forming apparatus 1 prohibits the output of the state information D12 acquired in step S14 (step S17). In this case, the failure analysis data D10 output from the image forming apparatus 1 does not include the state information D12.

If reference to the state information D12 is not prohibited (NO in step S16), the image forming apparatus 1 performs processing to invalidate at least one part of the state information D12 acquired in step S14 (step S18). That is, the image forming apparatus 1 specifies the information changed by the event that has occurred after the execution of the most recent job among the information included in the state information D12. The image forming apparatus 1 then deletes the specified information from the state information D12. Thus, the state information D12 becomes information that does not include information changed due to the occurrence of the event.

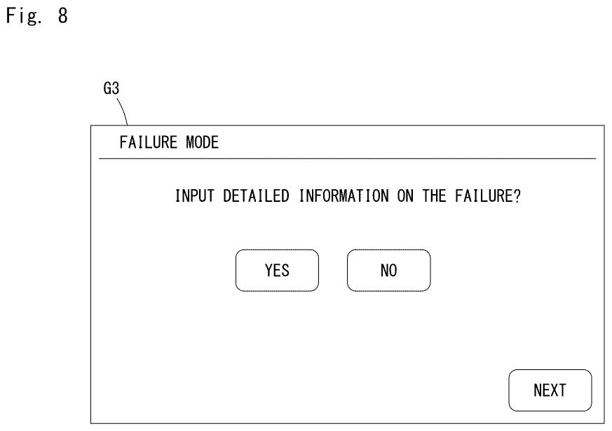

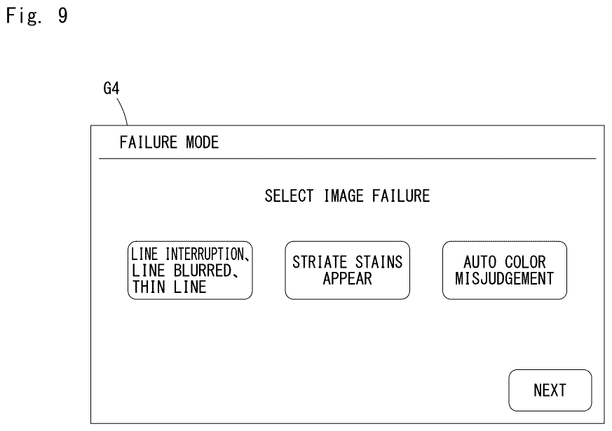

Next, the image forming apparatus 1 determines whether or not input of detailed information on the failure by the user has been accepted (step S19). For example, the image forming apparatus 1 displays an operation screen G3 as illustrated in FIG. 8 on the display section 14 of the operation panel 13. The operation screen G3 is a screen for asking the user whether or not to input detailed information on the failure. When input of detailed information is instructed by the user, the image forming apparatus 1 displays an operation screen G4 as illustrated in FIG. 9. Then, the image forming apparatus 1 receives a malfunction input operation by the user. In the example of FIG. 9, the screen is a screen for the user to select from among the following: a failure in which a line included in an output image has become thin, a failure in which streaky dirt appears in an output image, and a failure in which erroneous determination has been made in automatic color determination. The user can input a failure occurring in the output image by performing an operation on the operation screen G4.

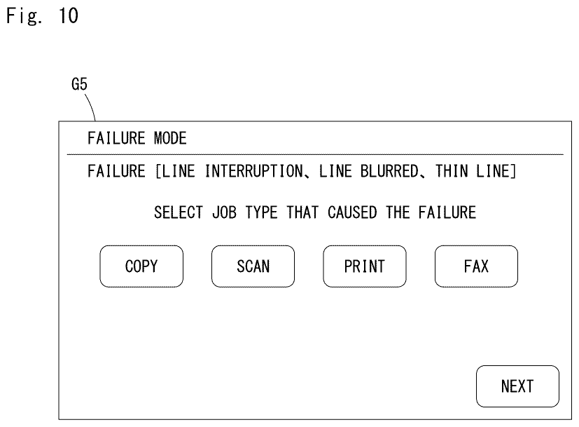

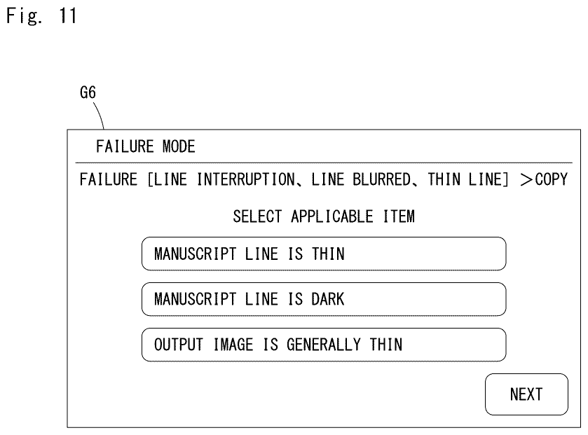

When the failure is input by the user, the image forming apparatus 1 displays an operation screen G5 as illustrated in FIG. 10 on the display section 14 of the operation panel 13. The operation screen G5 is a screen for inquiring of the user about the type of job in which the failure has occurred. When the type of job is specified by the user, the image forming apparatus 1 displays an operation screen G6 as illustrated in FIG. 11 on the display section 14 of the operation panel 13. The operation screen G6 is a screen for asking the user about a specific symptom of the failure. When the symptom of the failure is input by the user, the image forming apparatus 1 generates a failure detailed information based on the information input by the user.

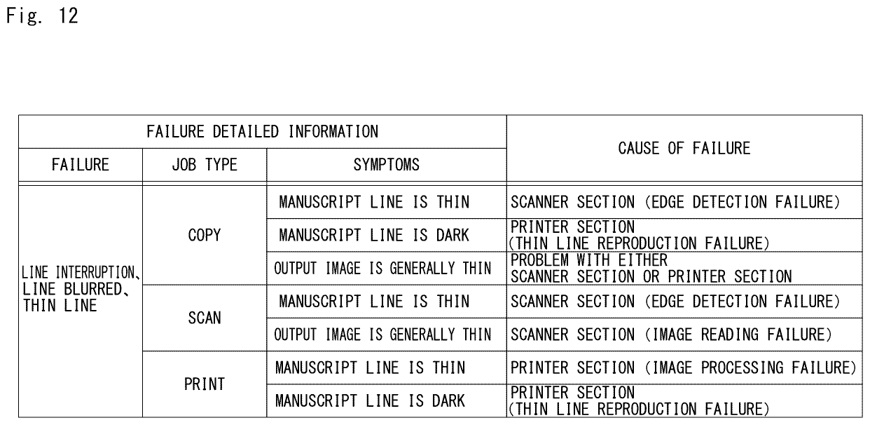

The failure detailed information input by the user is useful for narrowing down the cause of the failure. FIG. 12 illustrates a relation between the failure detailed information and a cause of the failure. As illustrated in FIG. 12, the cause of the failure varies depending on the combination of pieces of failure detailed information input by the user. Therefore, when the failure detailed information is included in the failure analysis data D10, the cause of the failure can be efficiently specified.

Furthermore, automatic execution of image stabilization processing and the like is prohibited while the failure detailed information is being input by the user. Therefore, the state information D12 is not rewritten while the user is inputting the failure detailed information.

Returning to the flowchart of FIG. 5, in a case where the input of the detailed information of the failure by the user is received (YES in Step S19), the image forming apparatus 1 generates the failure detailed information based on the information input by the user (Step S20). In addition, in a case where the input of the detailed information of the failure by the user is not received (NO in step S19), the image forming apparatus 1 does not generate the failure detailed information.

Thereafter, the image forming apparatus 1 generates and outputs the failure analysis data D10 (step S21). For example, when the image data D11 of the image including the failure is acquired in step S13, the image forming apparatus 1 generates the failure analysis data D10 including the image data D11. If the processes of steps S16 to 18 are not performed, the image forming apparatus 1 generates the failure analysis data D10 including the state information D12 acquired in step S14. In contrast, if the processing in steps S16 to S18 has been performed and the output of the state information D12 is restricted, the image forming apparatus 1 generates the failure analysis data D10 in which the output of the state information D12 is restricted. To be specific, when the output of the state information D12 is prohibited, the image forming apparatus 1 generates the failure analysis data D10 that does not include the state information D12. When a part of the information included in the state information D12 is invalidated, the image forming apparatus 1 generates the failure analysis data D10 including the state information D12 in which the part of the information is invalidated. Furthermore, when the processing of step S20 has been performed and the failure detailed information has been generated, the image forming apparatus 1 generates the failure analysis data D10 including the failure detailed information. The image forming apparatus 1 transmits the failure analysis data D10 to the information processing apparatus 3 via the communication interface 23.

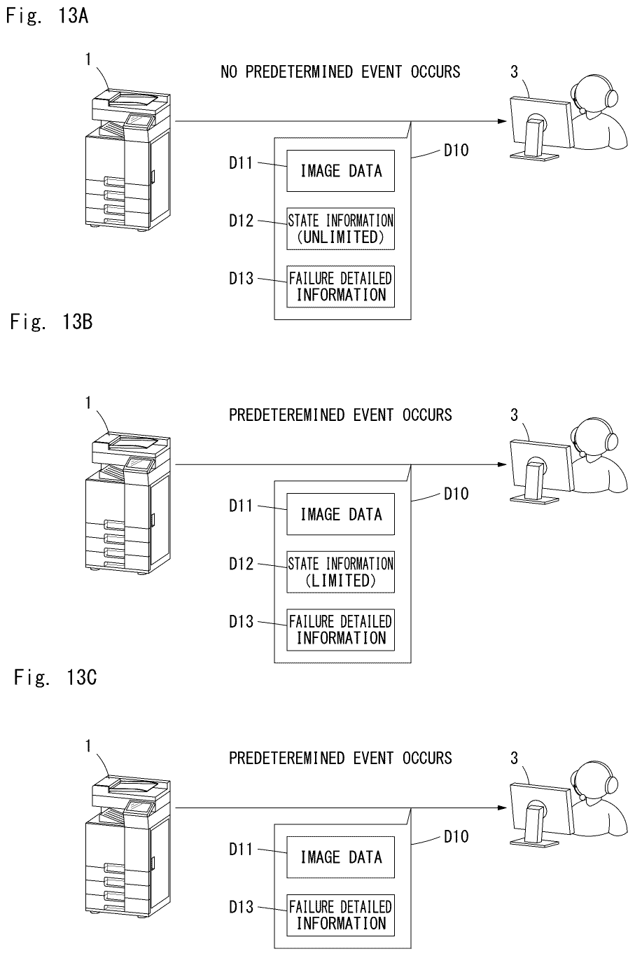

FIGS. 13A, 13B and 13C illustrate examples of the failure analysis data D10 transmitted from the image forming apparatus 1 to the information processing apparatus 3. FIG. 13A illustrates the failure analysis data D10 output when a predetermined event has not occurred after execution of the most recent job. When the predetermined event does not occur, the output of the state information D12 is not limited. Therefore, the failure analysis data D10 transmitted from the image forming apparatus 1 to the information processing apparatus 3 includes the state information D12 representing the internal state of the image forming apparatus 1 as it is. In this case, the operator can efficiently and accurately specify the cause of the failure based on the state information D12 included in the failure analysis data D10.

FIGS. 13B, and 13C illustrate the failure analysis data D10 output when a predetermined event occurs after execution of the most recent job. If the predetermined event has occurred after the execution of the most recent job, the image forming apparatus 1 outputs the failure analysis data D10 including limited state information D12, for example, as illustrated in FIG. 13B. The restricted state information D12 is information in which at least one part of information among multiple information representing the internal state of the image forming apparatus 1 is invalidated. The information to be invalidated is information that has been changed due to a predetermined event. Therefore, when the operator specifies the cause of the failure, the operator is not confused by the information changed by the predetermined event. Therefore, the operator can efficiently and accurately specify the cause of the failure based on the information included in the failure analysis data D10.

Furthermore, as illustrated in FIG. 13C, the image forming apparatus 1 may output the failure analysis data D10 that does not include the state information D12. Also in this case, the operator is not puzzled by the information changed by the predetermined event when identifying the cause of the failure. Therefore, the operator can efficiently and accurately specify the cause of the failure based on the information included in the failure analysis data D10.

As described above, when input of the failure information by the user is accepted, the image forming apparatus 1 according to the present embodiment determines whether or not a predetermined event has occurred during a period from execution of the most recent job to input of the failure information. As a result, when determining that the predetermined event has occurred, the image forming apparatus 1 restricts output of the state information D12 indicating the state of the inside of the apparatus. Therefore, information rewritten by an event after the occurrence of the failure can be excluded in identifying the cause of the failure. Therefore, it is possible to prevent a large amount of time from being taken to specify the cause of the occurrence of the failure, and it is possible to efficiently and accurately specify the cause of the occurrence of the failure.

### Second Embodiment

Next, a second embodiment of the present invention will be described. In the first embodiment, an example has been described in which it is determined whether or not a predetermined event has occurred after execution of the most recent job on the premise that the job in which the failure has occurred is the most recent job executed in the image forming apparatus 1. However, after the image forming apparatus 1 outputs an image having a failure, a certain time may elapse without a user noticing the failure. In such a case, after execution of the job that outputs the faulty image, the image forming apparatus 1 may execute another job. When another job is executed in the image forming apparatus 1, the internal state of the image forming apparatus 1 becomes completely different from the state at the time of the occurrence of the failure. Therefore, in this present embodiment, a description will be provided on an example of the image forming apparatus 1 that determines whether or not a job in which the failure has occurred is the most recent job. The configuration of the image forming apparatus 1 in the present embodiment is the same as that described in the first embodiment.

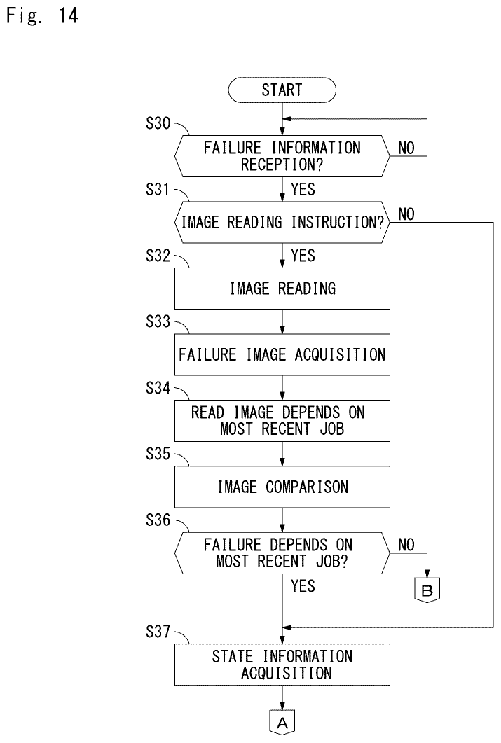

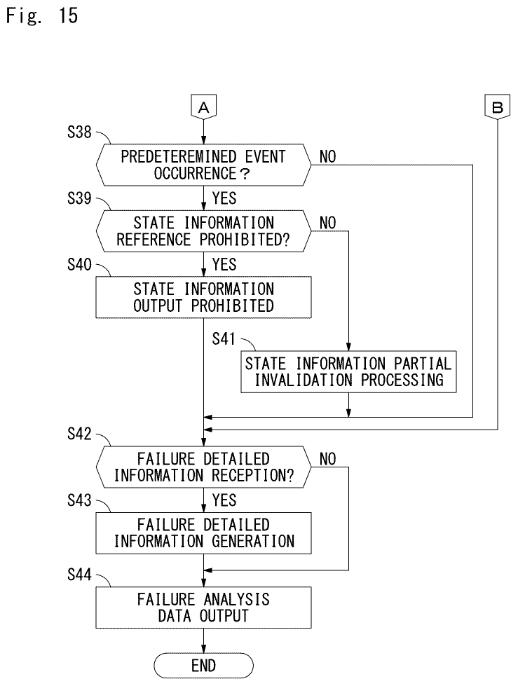

FIGS. 14 and 15 are flowcharts illustrating an example of a processing procedure performed in the image forming apparatus 1 according to the second embodiment. This processing is processing mainly performed by the failure controller 40. The image forming apparatus 1 waits until input of the failure information by the user is accepted (step S30). When the input of the failure information is received (YES in step S30), the image forming apparatus 1 shifts to the failure mode.

Upon transitioning to the failure mode, the image forming apparatus 1 determines whether or not an image reading instruction has been given by the user (step S31). When the image reading instruction has been issued (YES in step S31), the image forming apparatus 1 drives the scanner section 20 to read the image of the document (step S32), and acquires the image data D11 of the image including the failure (step S33). Furthermore, the image forming apparatus 1 may not only read the image of the document but also acquire the image data D11 of the image including the failure from the image data 18 stored in the storage section 16.

Upon acquiring the image data D11 on the image including the failure, the image forming apparatus 1 reads the image data acquired by the most recent job from the storage section 16 (step S34). The image forming apparatus 1 compares the faulty image data D11 with the image data acquired in the most recent job (step S35). By comparing the two pieces of image data, the image forming apparatus 1 determines whether or not the two pieces of image data are the same image data. For example, when the degree of similarity between two pieces of image data is higher than a predetermined value, the image forming apparatus 1 determines that the two pieces of image data are the same image data.

The image forming apparatus 1 determines, as a result of the image comparison, whether or not the failure included in the image data D11 acquired in step S33 is caused by the most recent job (step S36). When the failure included in the image data D11 is the failure caused by the most recent job (YES in step S36), the image forming apparatus 1 acquires the state information D12 (step S37). Upon acquiring the state information D12, the processing by the image forming apparatus 1 proceeds to the flowchart of FIG. 15, and executes the processing of steps S38 to S41. The processing of steps S38 to S41 are the same as the processing of steps S15 to S18 illustrated in FIG. 5. That is, the image forming apparatus 1 determines whether or not a predetermined event has occurred after execution of the most recent job (step S38). As a result, when the predetermined event has occurred (YES in step S38), the image forming apparatus 1 restricts the output of the state information D12 acquired in step S37 (steps S39 to S41). In a case where the predetermined event has not occurred (NO in step S38), the image forming apparatus 1 does not restrict the output of the state information D12 and allows the state information D12 to be output as it is. Thereafter, the processing by the image forming apparatus 1 proceeds to step S42.

On the other hand, in a case where the failure included in the image data D11 is not the failure caused by the most recent job (NO in step S36), the image forming apparatus 1 does not acquire the state information D12. This is because the state information D12 has already been changed from the information at the time of occurrence of the failure. In this case, the processing by the image forming apparatus 1 proceeds to step S42. That is, the image forming apparatus 1 restricts output of the state information D12 without acquiring the state information D12.

Next, the image forming apparatus 1 determines whether or not input of detailed information on the failure by the user has been accepted (step S42). When the image forming apparatus 1 receives the input of the detailed information of the failure by the user (YES in step S42), the image forming apparatus 1 generates the failure detailed information based on the information input by the user (step S43). In addition, in a case where the input of the failure detailed information by the user is not received (NO in step S42), the image forming apparatus 1 does not generate the failure detailed information. Thereafter, the image forming apparatus 1 generates and outputs failure analysis data D10 (step S44).

The image forming apparatus 1 of the present embodiment stores at least the image data 18 acquired by the execution of the most recent job in the storage section 16. Upon acquiring the image data D11 of the image including the failure, the image forming apparatus 1 compares the image data 18 stored in the storage section 16 with the image data D11 to determine whether or not the image data D11 is the image output by execution of the most recent job. As a result, when the image data D11 is not the image output by execution of the most recent job, the image forming apparatus 1 restricts output of the state information D12. Therefore, it is possible to prevent a lot of time from being taken to specify the cause of the occurrence of the failure in the image forming apparatus 1, and it is possible to efficiently and accurately specify the cause of the occurrence of the failure.

Note that the configuration and operation of this embodiment other than those described above are the same as those described in the first embodiment.

### Third Embodiment

Next, third embodiment of the present invention will be described. In the present embodiment, an example in which the image forming apparatus 1 includes the failure analysis section 47 will be described.

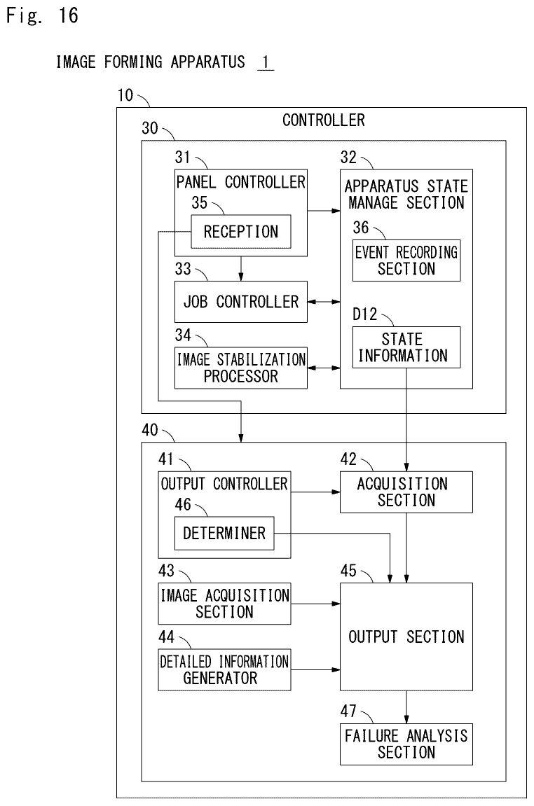

FIG. 16 is a block diagram illustrating the functional configuration of the controller 10 in the image forming apparatus 1. The controller 10 of the present embodiment includes a failure analysis section 47 that operates in the failure mode. The failure analysis section 47 is a processing section that analyzes the failure based on the failure analysis data D10 to identify the cause of the failure. The output section 45 according to the present embodiment outputs the failure analysis data D10 to the failure analysis section 47. The failure analysis section 47 comes into operation when the failure analysis data D10 is outputted from the output section 45, and analyzes the failure that has occurred in the image forming apparatus 1.

In a case where failure detailed information is input by the user, the failure detailed information is included in the failure analysis data D10. When acquiring the failure analysis data D10, the failure analysis section 47 extracts the failure detailed information from the failure analysis data D10, and narrows down and specifies the cause of the failure based on the failure detailed information. When specifying the cause of the failure, the failure analysis section 47 refers to the image data D11 and the state information D12 included in the failure analysis data D10 to specify the cause of the failure. At this time, similarly to the first embodiment and the second embodiment, if the information included in the state information D12 has been changed since the occurrence of the failure, the changed information is excluded. Therefore, the failure analysis section 47 can efficiently and accurately specify the cause of the failure.

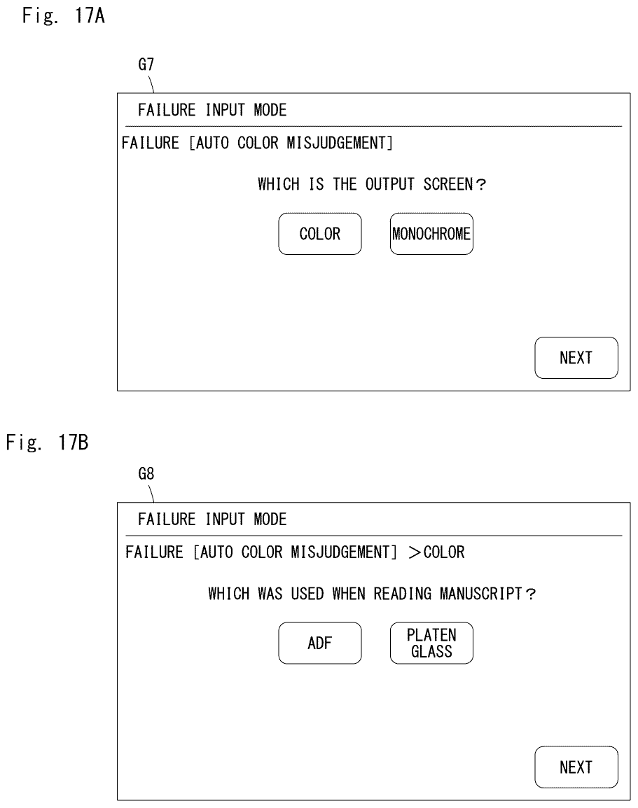

FIGS. 17A and 17B illustrate operation screens to be displayed when the user selects the incorrect determination of automatic color in the operation screen G4 illustrated in FIG. 9. For example, the operation screen G7 illustrated in FIG. 17A is a screen for inquiring of the user whether the image output due to the erroneous determination is a color image or a monochrome image. When the operation screen G7 is displayed, if the user selects a color image, an operation screen G8 illustrated in FIG. 17B is further displayed. The operation screen G8 is a screen for inquiring of the user whether the ADF is used or the platen glass is used at the time of document reading. As described above, the detailed information on the failure is input by the user, and thus the failure analysis section 47 can specify the cause of the occurrence of the failure and can guide the user to a solution for the failure.

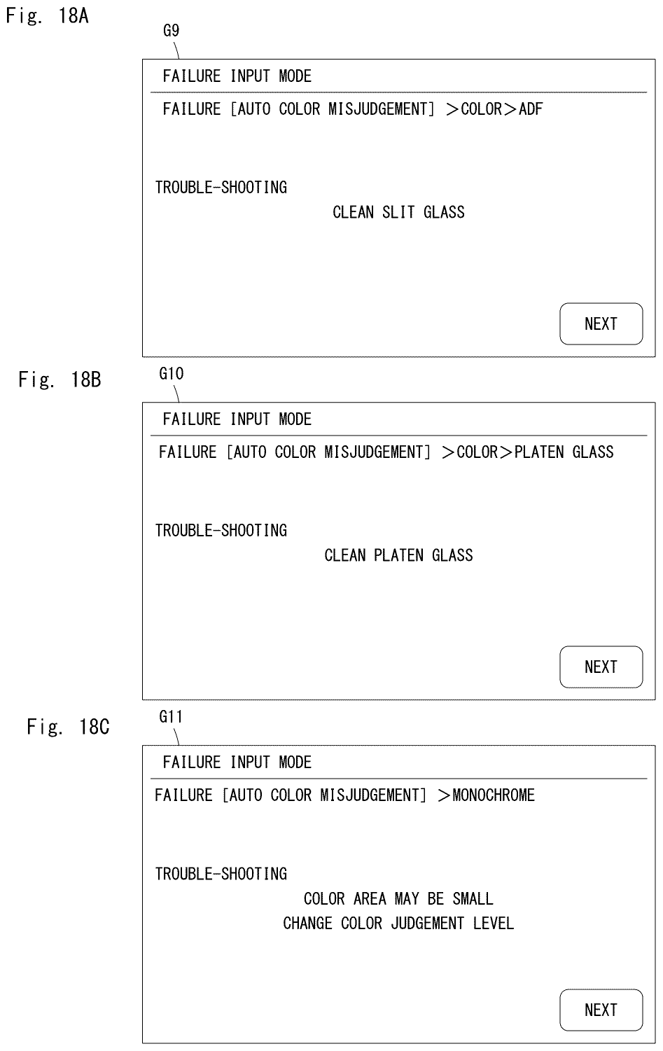

FIGS. 18A, 18B and 18C illustrate screen examples for guiding a user to a solution to the failure. For example, in a case where a color image is output due to the erroneous determination of the automatic color and the user designates that the document is read by using the ADF, a guide screen G9 as illustrated in FIG. 18A is displayed on the display section 14. The guide screen G9 guides the user to clean the slit glass.

In addition, for example, in a case where a color image is output due to the erroneous determination of the automatic color and the user designates that the document is read by using the platen glass, a guide screen G10 as illustrated in FIG. 18B is displayed on the display section 14. The guide screen G10 guides a user to clean the platen glass.

Further, for example, when it is designated that the monochrome image is output due to the erroneous determination of the automatic color, a guide screen G11 as illustrated in FIG. 18C is displayed on the display section 14. The guide screen G11 guides the user to change the color determination level.

Note that in FIGS. 18A, 18B and 18C, the case where the user himself/herself can solve the failure is illustrated. However, the user himself/herself might not be able to resolve the failure depending on the analysis result by the failure analysis section 47. In such a case, the failure analysis section 47 may display, on the display section 14, a guidance screen prompting the user to call a service person.

Further, in the present embodiment, the case where the failure analysis section 47 is mounted on the image forming apparatus 1 has been exemplified. However, it is not limited thereto, and the failure analysis section 47 may be provided as an external apparatus of the image forming apparatus 1. In that case, the failure analysis section 47 provided as an external apparatus automatically specifies the cause of the failure.

In addition, configurations and operations other than the above described points in the present embodiment are the same as those described in the first embodiment or the second embodiment.

### Modification Example

The present invention is not limited to the content described in the above embodiment, and various modification examples are applicable.

For example, in the above-described embodiment, the case where the operation mode of the image forming apparatus 1 is shifted to the failure mode by the user of the image forming apparatus 1 inputting the failure information via the operation panel 13 has been exemplified. However, the embodiment is not limited thereto. For example, the image forming apparatus 1 may receive the failure information from an external information processing apparatus 3. Therefore, the image forming apparatus 1 may be configured to shift to the failure mode also when failure information is input from the external information processing apparatus 3. For example, the information processing apparatus 3 may transmit the failure information to the image forming apparatus 1 based on an instruction from the operator and shift the image forming apparatus 1 to a failure mode, thereby acquiring the failure analysis data D10.

Furthermore, the case where the program 17 described in the above embodiment is stored in advance in the image forming apparatus 1 has been illustrated. However, the program 17 is not limited to a program stored in advance in the image forming apparatus 1. For example, the program 17 may be a subject of trading by itself. In this case, the program 17 may be provided in a downloadable manner via the network 2 such as the Internet. Further, the program 17 may be provided in a state of being recorded in a computer-readable recording medium such as a CD-ROM or a USB memory.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that executes a job and outputs an image, comprising:
a hardware processor that:
receives input of failure information indicating that a failure has occurred due to execution of the job;
acquires state information inside the image forming apparatus when receiving the input of the failure information;
outputs the state information for failure analysis;
determines whether or not a predetermined event has occurred during a period from execution of a most recent job to the input of the failure information when the input of the failure information is received; and
restricts output of the state information at a time of the output for failure analysis when the predetermined event has occurred.

2. The image forming apparatus according to claim 1, wherein
the hardware processor prohibits the output of the state information when the predetermined event has occurred.

3. The image forming apparatus according to claim 1, wherein
when the predetermined event has occurred, the hardware processor invalidates at least one of multiple pieces of information included in the state information and causes the state information to be output.

4. The image forming apparatus according to claim 1, wherein
the hardware processor further acquires image data of an image including a failure, and outputs the acquired image data together with the state information.

5. The image forming apparatus according to claim 4, further comprising:
an image reader that reads an image of a document, wherein
the hardware processor acquires image data of the image read by the image reader as the image data including the failure.

6. The image forming apparatus according to claim 1, wherein
the predetermined event includes an event in which an internal setting state changes.

7. The image forming apparatus according to claim 1, wherein
the predetermined event includes an event automatically executed to stabilize the image.

8. The image forming apparatus according to claim 1, wherein
the predetermined event includes an event of transitioning to a logged in state by a user different from a user who has executed the most recent job.

9. The image forming apparatus according to claim 1, wherein
the predetermined event includes an event in which a predetermined time has elapsed since execution of the most recent job.

10. The image forming apparatus according to claim 1, wherein
the predetermined event includes an event in which a power is turned off.

11. The image forming apparatus according to claim 1, further comprising:
a storage that stores image data acquired by the execution of the most recent job, wherein
the hardware processor further acquires image data of an image including a failure;
determines whether or not the acquired image data is the image outputted by the execution of the most recent job by comparing the image data stored in the storage with the acquired image data; and
restricts the output of the state information when the acquired image data is not the image outputted by the execution of the most recent job.

12. The image forming apparatus according to claim 11, wherein
the storage accumulates and stores the image data each time the job is executed, and
the hardware processor acquires the image data designated by a user as the image data including the failure from among multiple pieces of the image data stored in the storage.

13. The image forming apparatus according to claim 1, wherein
the hardware processor outputs the state information to an external apparatus via a network.

14. The image forming apparatus according to claim 1, further comprising:
an operation device that receives an input operation of failure detailed information by a user, wherein
the hardware processor outputs the failure detailed information input from the operation device.

15. The image forming apparatus according to claim 14, wherein
the hardware processor prohibits execution of processing to be automatically executed for stabilizing an image when the operation device receives the input operation.

16. A control method for a case where a failure occurs in an image outputted in an image forming apparatus that executes a job and outputs the image, the control method comprising:
receiving input of failure information indicating that the failure has occurred due to execution of the job;
acquiring state information inside the image forming apparatus in response to receiving the input of the failure information;
outputting the state information for failure analysis;
determining whether or not a predetermined event has occurred during a period from execution of a most recent job to the input of the failure information when the input of the failure information is received; and
restricting the output of the state information at a time of output for failure analysis when the predetermined event has occurred.

17. A non-transitory computer-readable recording medium storing a program to be executed in an image forming apparatus to execute a job and output an image, the program causing the image forming apparatus to perform:
receiving input of failure information indicating that a failure has occurred due to execution of the job;
acquiring state information inside the image forming apparatus in response to receiving the input of the failure information;
outputting the state information for failure analysis;
determining whether or not a predetermined event has occurred during a period from execution of a most recent job to the input of the failure information when the input of the failure information is received; and
restricting the output of the state information at a time of output for failure analysis when the predetermined event has occurred.
